(19) United States
(12) Patent Application Publication
(10) Pub. No.: US 2025/0033315 A1
(43) Pub. Date: Jan. 30, 2025

(54) MULTILAYER POUCH WITH OXYGEN BARRIER TECHNOLOGY

(71) Applicant: LNJ Group, LLC, Glen Head, NY (US)

(72) Inventor: Pamela Dozier, Doylestown, PA (US)

(73) Assignee: LNJ Group, LLC, Glen Head, NY (US)

(21) Appl. No.: 18/360,760

(22) Filed: Jul. 27, 2023

(51) Int. Cl. B32B 1/02; B32B 15/09; B32B 15/20; B32B 43/00

(52) U.S. Cl. CPC B32B 1/00; B32B 15/09; B32B 15/20; B32B 43/003; B32B 2250/04; B32B 2307/7244; B32B 2439/70

(57) ABSTRACT

In some embodiments, a wine pouch for use in a beverage dispensing machine is disclosed. The pouch includes multiply layers and has oxygen barrier properties. The pouch includes a polyethylene terephthalate (PET) film layer. The pouch further includes a first oxygen barrier layer including aluminum and a second oxygen barrier layer including aluminum oxide. The pouch further includes a sealant layer including metallocene linear low density polyethylene (mLLDPE).

### CROSS REFERENCE TO RELATED APPLICATIONS

The present application is related to U.S. patent application Ser. No. 17/548,353 titled “BEVERAGE DISPENSING MACHINE AND POUCH FOR USE WITH BEVERAGE DISPENSING MACHINE” filed Dec. 10, 2021, now pending, which is a continuation-in-part and claims the benefit of U.S. patent application Ser. No. 16/553,168 titled “BEVERAGE DISPENSING MACHINE AND POUCH FOR USE WITH BEVERAGE DISPENSING MACHINE” filed Aug. 27, 2019 (now U.S. Pat. No. 11,608,259 issued on Mar. 21, 2023), which claims priority to U.S. Provisional Application No. 62/723,068 filed on Aug. 27, 2018, titled “BEVERAGE DISPENSING MACHINE AND POUCH FOR USE WITH BEVERAGE DISPENSING MACHINE,” the disclosures of which are hereby incorporated by reference in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE SPECIFICATION

This application generally relates to a multilayer pouch, and in particular, a pouch with oxygen barrier technology.

Wine is a favorite evening and bar product for many adults. The top 30% of alcohol consumers in the United States have, on average, one glass of wine per day. A standard bottle of wine holds 750 mL or 25.4 oz., which is equivalent to approximately six glasses of wine. Thus, the average wine consumer will typically drink a bottle of wine over the course of six days.

Opening a bottle of wine exposes the alcohol to an environment full of air, which contains 21% oxygen. This causes the wine to begin to oxidize. Oxidation occurs when a wine's exposure to air triggers a series of chemical reactions that convert ethanol, or alcohol, into acetaldehyde. Oxidation—the same process which turns a cut apple brown or causes an avocado to change in taste—has destructive effects on wine as well. Even when re-corked, wine will continue to change rapidly once opened and can soon become overly oxidized, resulting in a loss of vibrancy in both color and flavor.

The single-serve beverage category is expanding due to added consumer convenience and other factors such as ease of use. Some manufacturers have begun selling single-serve wines in small bottles or hard containers, such as wine glasses that include a removable seal around the opening. Several manufacturers are selling single-serve wine in soft pouches, while others sell single-serve brick packs of wine.

The flexible packaging market continues to grow due to its convenience and portability. The flexible packaging segment is the largest packaging segment worldwide, comprising 29% of all packaging types. One type of flexible packaging is a pouch, such as a four-sided pouch or a pouch with a bottom gusset. Over time, oxygen begins to permeate the packaging material of flexible pouches. Thus, beverages such as wine contained in pouches are at risk of oxygen exposure and the destructive effects of oxidation.

The disclosed multilayer pouch with oxygen barrier technology fills a gap in the market for preventing oxidation of perishable beverages such as wine and preserving both quality and flavor. The application of oxygen barrier technology to a multilayer pouch allows storage of wine for extended periods of time, providing a shelf-life of at least 18-24 months. The multilayer pouch may be configured for use with a beverage dispensing machine and vastly increases consumers' options for enjoying wine.

### SUMMARY

A wine pouch for use in a beverage dispensing machine, the pouch comprising multiple layers and having oxygen barrier properties, is disclosed. The pouch comprises a polyethylene terephthalate (PET) film layer. The pouch further comprises a first oxygen barrier layer comprising aluminum and a second oxygen barrier layer comprising aluminum oxide. The pouch further comprises a sealant layer comprising metallocene linear low density polyethylene (mLLDPE).

In some embodiments, the pouch comprises a bottom gusset. In some embodiments, the pouch comprises one or more additional layers, for example, a third oxygen barrier layer. In some embodiments, the beverage dispensing machine comprises a cutting mechanism configured to open the pouch to release the wine therefrom. In some embodiments, the pouch includes a barcode on the outermost layer, the barcode comprising code data configured to control operation of the beverage dispensing machine. In some embodiments, the pouch includes a trademark on the outermost layer, the trademark comprising code data configured to control operation of the beverage dispensing machine.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

The embodiments illustrated in the figures of the accompanying drawings which are meant to be exemplary and not limiting, in which like references are intended to refer to like or corresponding parts.

FIG. 1 illustrates a cross-sectional view of a multilayer material with oxygen barrier technology according to an embodiment.

FIG. 2 illustrates a front view of a pouch comprising multiple layers and having oxygen barrier technology according to an embodiment.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the described embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. The following detailed description is, therefore, not intended to be taken in a limiting sense.

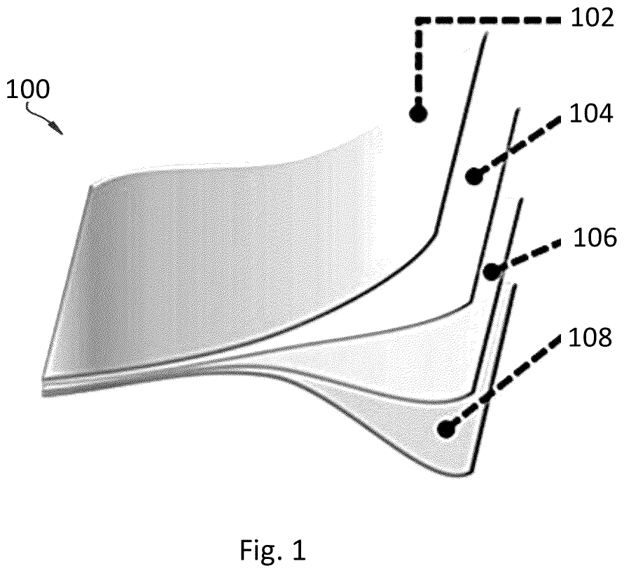

FIG. 1 presents a cross-sectional view of the layers of a multilayer material with oxygen barrier technology according to an embodiment. The multilayer material 100 with oxygen barrier technology may be used for lining a wine pouch. The multilayer material 100 comprises a polyethylene terephthalate (PET) film layer 102, a first oxygen barrier layer comprising aluminum 104, a second oxygen barrier layer comprising aluminum oxide 106, and a sealant layer comprising metallocene linear low density polyethylene (mLLDPE) 108. Polyethylene is a common thermoplastic polymer material, commonly used as a flexible packaging material. PET is a clear, strong, and lightweight thermoplastic polymer resin of the polyester family, used in fibers for clothing and in containers for liquids and foods. Metallocene LLDPE is a form of linear low density polyethylene produced using a metallocene catalyst. mLLDPE enables the production of stronger films with improved properties such as high resistance to puncture and damage as well as high tensile strength. Aluminum's ability to form any shape and its protective qualities make it a versatile packaging material. When aluminum comes in contact with oxygen, it forms a thin oxide barrier layer. Aluminum oxide serves as a protective layer with extremely high moisture and gas barrier properties, thereby preventing oxidation.

In some embodiments, the film layer 102 may comprise an alternate polyester. In some embodiments, the sealant layer 108 of the multilayer material 100 may comprise an alternate thermoplastic resin such as high density polyethylene, medium density polyethylene, or low density polyethylene. While four layers are shown, in some embodiments, the multilayer material 100 may comprise one or more additional layers. While two oxygen barrier layers are shown, the number and types of oxygen barrier layers in the multilayer material 100 are not specifically limited. The multilayer material 100 may comprise one or more of a third and fourth oxygen barrier layer. For example, a third oxygen barrier layer may be disposed between the first 104 and second 106 oxygen barrier layers, and may comprise nylon. Nor are the order and arrangement of layers 102-108 in the multilayer material 100 specifically limited. For example, the first oxygen barrier layer comprising aluminum 104 may be situated adjacent to the sealant layer 108, and the second oxygen barrier layer comprising aluminum oxide 106 may be situated adjacent to the film layer 102. In some embodiments, each layer of the multilayer material 100 is in direct contact with at least one adjacent layer and, preferably, all layers of the multilayer material are in direct contact with their adjacent layers as shown in FIG. 1.

In some embodiments, a wine pouch lined with the multilayer material 100 may be used in a beverage dispensing machine. In some embodiments, the multilayer material 100 may comprise films, sheets, fibers, fabrics, or other forms. Other materials presently known or developed in the future may alternatively be utilized.

In some embodiments, a wine pouch is made for use in a beverage dispensing machine, wherein the pouch comprises multiple layers and has oxygen barrier properties. The method comprises placing a first layer that is a PET film layer 102, placing a second layer that is an oxygen barrier layer comprising aluminum 104, placing a third layer that is an oxygen barrier layer comprising aluminum oxide 106, and placing fourth layer that is a sealant layer comprising mLLDPE 108. The method may further comprise placing one or more additional layers, for example, a third oxygen barrier layer.

In some embodiments, the pouch is made with a bottom gusset. In some embodiments, the layers of the pouch are made to be thin enough such that the pouch may be opened by a cutting mechanism in the beverage dispensing machine. In some embodiments, the method includes placing a barcode or a trademark on the outermost layer of the pouch. The barcode or trademark may include code data configured to control the operation of the beverage dispensing machine.

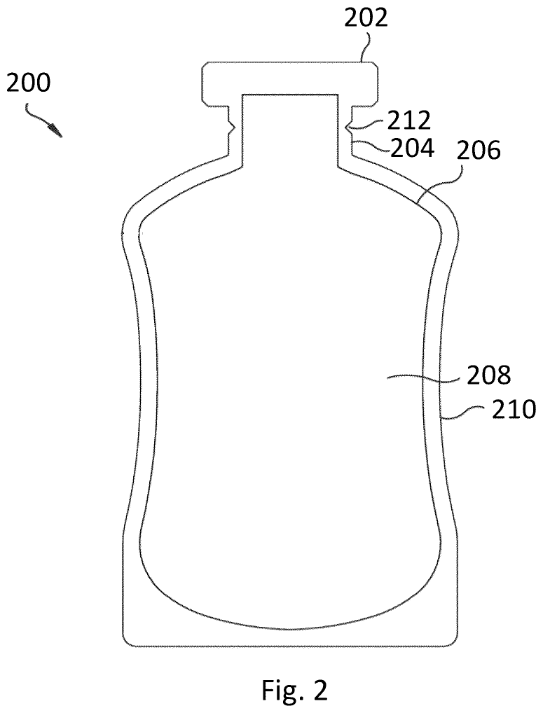

FIG. 2 presents a front view of an exemplary wine pouch for use in a beverage dispensing machine according to an embodiment. The pouch comprises multiple layers and has oxygen barrier properties. Exemplary beverage dispensing machines with which the presently claimed pouches can be used are disclosed in prior patent applications filed by the assignee of the present application including the ones identified above as Ser. Nos. 17/548,353 and 16/553,168 and incorporated herein by reference. The multilayer pouch 200 with oxygen barrier technology comprises a PET film layer, a first oxygen barrier layer comprising aluminum, a second oxygen barrier layer comprising aluminum oxide, and a sealant layer comprising mLLDPE. In some embodiments, the film layer may comprise an alternate polyester. In some embodiments, the sealant layer may comprise an alternate thermoplastic resin such as high density polyethylene, medium density polyethylene, or low density polyethylene. The number and types of oxygen barrier layers in the multilayer pouch 200 are not specifically limited. For example, the multilayer pouch 200 may comprise one or more of a third and fourth oxygen barrier layer. Nor are the order and arrangement of the layers in the multilayer pouch 200 specifically limited. For example, the first oxygen barrier layer comprising aluminum may be situated adjacent to the sealant layer, and the second oxygen barrier layer comprising aluminum oxide may be situated adjacent to the film layer.

According to an embodiment, the multilayer pouch 200 may comprise an outer perimeter 210 such that its profile resembles a bottle. The multilayer pouch 200 may comprise a rectangular cap 202, a rectangular neck 204, and sloping, curved shoulders 206 that extend downward from the neck 204. The side edges of the multilayer pouch 200 are concave, curving inward until hitting a vertical portion towards the bottom of the side edges. The vertical portion of the side edges is positioned directly adjacent the bottom surface of the multilayer pouch 200, which is flat. The internal shape of the bladder 208 of the multilayer pouch 200 is shown as following the shape of the outer edges of the multilayer pouch 200. At the top end, the bladder 208 starts directly adjacent the bottom of the neck 204. The walls of the bladder 208 have a curved shape in the bottom corners. The curved shape does not match the rectangular shape of the exterior walls of the multilayer pouch 200. In addition, the multilayer pouch 200 may include an indented tear portion 212 in the neck 204 that permits the multilayer pouch 200 to be torn, cut, slices, or otherwise opened more easily.

In some embodiments, the multilayer pouch 200 may comprise one or more additional layers in addition to those described above. The one or more additional layers may comprise a third oxygen barrier layer comprising, for example, nylon. In some embodiments, the layers with oxygen barrier technology of the multilayer pouch 200 may comprise films, sheets, fibers, fabrics, or other materials. Other materials presently known or developed in the future may alternatively be utilized. The term pouch is used herein to refer to a flexible soft pouch, but can also refer to a non-soft pouch, e.g., one having non-flexible parts, or a molded beverage container. The term pouch is meant as a universal term herein for describing a receptacle for holding a liquid.

The multilayer pouch 200 may be used as a method of storage, wherein the layers comprising oxygen barrier properties of the multilayer pouch 200 make it ideal for storing various beverages which spoil in the presence of oxygen. Such beverages may include alcoholic drinks such as wine, beer, champagne, liqueur, or other spirits, as well as other liquids such as juice, soft drinks, tea, coffee, or milk.

The multilayer pouch 200 may be configured for use with an exemplary beverage dispensing machine according to an embodiment. In one embodiment, the multilayer pouch 200 may be constructed in a variety of shapes and sizes to be configured for use with beverage dispensing machines of various sizes. In some embodiments, the multilayer pouch 200 may be constructed in a variety of shapes and sizes depending on the substance the pouch is configured to hold. For example, the multilayer pouch 200 may be a stand-up pouch that has a sealed, gusseted bottom, as known by those skilled in the art. Alternatively, the multilayer pouch 200 may comprise a four-sided pouch that is entirely sealed around a single edge of the perimeter of the pouch, a pillow pouch, a vacuum pouch, or any other shape such that the multilayer pouch 200 is suitably configured to hold a given substance.

In one embodiment, the multilayer pouch 200 may measure 184.15 millimeters in length and 95.25 millimeters in outer diameter width. In one embodiment, the multilayer pouch 200 may comprise a bottom gusset, which may measure 50.8 millimeters. The multilayer pouch 200 may be configured to hold at least five (5) ounces of liquid or more, depending on the desired serving size. In other embodiments, any other size, length, or width may alternatively be used.

According to an embodiment, the multilayer pouch 200 may include code data embedded in a barcode or a Quick Response (“QR”) code, which may be displayed on the exterior, or outermost layer. The code data includes parameters for processing the beverage in the multilayer pouch 200 including beverage type, ideal serving temperature, and ideal aeration. The code data may include further information regarding the wine in the multilayer pouch 200 such as the year of the vintage, vineyard or region of origin, wine maker, grape variety, food pairings, tasting notes, aromas, viscosity, sediments, production method, wine ratings/user reviews, packager/packaging facility, and date of packaging. According to an embodiment, the multilayer pouch 200 may include a trademark with embedded data displayed on the exterior, or outermost layer. The trademark may be scanned and read by the beverage dispensing machine. The beverage dispensing machine may authorize use of the multilayer pouch 200 and authenticate the contents as licensed or trustworthy based on the embedded data of the trademark and the code data of the barcode or QR code. Operation of the beverage dispensing machine may be controlled based on the trademark and some or all of the parameters included in the code data.

The code data may also include parameters such as ideal serving temperature, time, ideal aeration, and other information to control how a beverage in a pouch is processed. The code data may also include information including year of vintage, vineyards, grape varietal, food pairings, tasting notes, regions, wine makers, aromas, viscosity, sediments, production method, wine ratings/user reviews, packager/packaging facility, and date of packaging.

According to an embodiment, the beverage dispensing machine has a cutting mechanism that opens the multilayer pouch 200 to release the beverage therefrom. The cutting mechanism may include a cutting blade, wherein the cutting blade may be coupled to a motor that moves the blade in and out of contact with the multilayer pouch 200 to repeatedly cut and agitate the multilayer pouch 200. The movement of the cutting blade may also cause aeration of the beverage. According to some embodiments, the beverage dispensing machine may utilize other opening techniques including slicing, piercing, or squeezing the multilayer pouch 200.

FIGS. 1 through 2 are conceptual illustrations allowing for an explanation of the illustrative embodiments. Notably, the figures and examples above are not meant to limit the scope of the illustrative embodiments to a single embodiment, as other embodiments are possible by way of interchange of some or all of the described or illustrated elements. Moreover, where certain elements of the illustrative embodiments can be partially or fully implemented using known components, only those portions of such known components that are necessary for an understanding of the illustrative embodiments are described, and detailed descriptions of other portions of such known components are omitted so as not to obscure the embodiments. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the illustrative embodiments encompass present and future known equivalents to the known components referred to herein by way of illustration.

The foregoing description will so fully reveal the general nature of the illustrative embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the illustrative embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A wine pouch for use in a beverage dispensing machine, the pouch comprising multiple layers and having oxygen barrier properties, the pouch comprising:
a polyethylene terephthalate film layer;
a first oxygen barrier layer comprising aluminum;
a second oxygen barrier layer comprising aluminum oxide; and
a sealant layer comprising metallocene linear low density polyethylene.

2. The pouch of claim 1, wherein the pouch further comprises a bottom gusset.

3. The pouch of claim 1, wherein the pouch comprises one or more additional layers.

4. The pouch of claim 3, wherein the one or more additional layers comprise a third oxygen barrier layer.

5. The pouch of claim 1, wherein the beverage dispensing machine comprises a cutting mechanism configured to open the pouch to release the wine therefrom.

6. The pouch of claim 1, wherein the pouch includes a barcode on the outermost layer of the pouch, the barcode comprising code data configured to control operation of the beverage dispensing machine.

7. The pouch of claim 1, wherein the pouch includes a trademark on the outermost layer of the pouch, the trademark comprising embedded data configured to control operation of the beverage dispensing machine.

8. A method of making a wine pouch for use in a beverage dispensing machine, the pouch comprising multiple layers and having oxygen barrier properties, the method comprising:
placing a first layer that is a polyethylene terephthalate film layer;
placing a second layer that is an oxygen barrier layer comprising aluminum;
placing a third layer that is an oxygen barrier layer comprising aluminum oxide; and
placing fourth layer that is a sealant layer comprising metallocene linear low density polyethylene.

9. The method of claim 8, wherein making the pouch further comprises making the pouch with a bottom gusset.

10. The method of claim 8, wherein making the pouch further comprises placing one or more additional layers.

11. The method of claim 10, wherein the one or more additional layers comprise a third oxygen barrier layer.

12. The method of claim 8, wherein making the pouch further comprises making the layers thin enough such that the pouch is configurable to be opened by a cutting mechanism in the beverage dispensing machine.

13. The method of claim 8, wherein making the pouch further comprises placing a barcode on the outermost layer of the pouch, the barcode comprising code data configured to control operation of the beverage dispensing machine.

14. The method of claim 8, wherein making the pouch further comprises placing a trademark on the outermost layer of the pouch, the trademark comprising embedded data configured to control operation of the beverage dispensing machine.

15. A multilayer material for use in lining a wine pouch and having oxygen barrier properties, the multilayer material comprising:
a polyethylene terephthalate film layer;
a first oxygen barrier layer comprising aluminum;
a second oxygen barrier layer comprising aluminum oxide; and
a sealant layer comprising metallocene linear low density polyethylene.

16. The multilayer material of claim 15, wherein the multilayer material comprises one or more additional layers.

17. The multilayer material of claim 16, wherein the one or more additional layers comprise a third oxygen barrier layer.

18. The multilayer material of claim 17, wherein the third oxygen barrier layer is disposed in between the first and second oxygen barrier layers.

19. The multilayer material of claim 15, wherein the multilayer material is configured to be in the form of at least one of a film, sheet, fiber, or fabric.

20. The multilayer material of claim 15, wherein each layer is in direct contact with at least one adjacent layer.
